(19) United States
(12) Patent Application Publication
(10) Pub. No.: US 2025/0223060 A1
(43) Pub. Date: Jul. 10, 2025

(54) SYSTEMS AND METHODS FOR CONTROLLING HYBRID MULTI-ROTOR AERIAL VEHICLES

(71) Applicant: COPTERPIX PRO LTD, Kibbutz Karmia (IL)

(72) Inventors: Eli SAYAG, Sderot (IL); Alon SVIRSKY, Even Yehuda (IL)

(21) Appl. No.: 18/852,511

(22) PCT Filed: Apr. 16, 2023
(86) PCT No.: PCT/IB2023/053884

§ 371 Date: Sep. 30, 2024

Related U.S. Application Data
(60) Provisional application No. 63/331,301, filed on Apr. 15, 2022.

(51) Int. Cl. B64U 30/29; B64U 10/10; B64U 50/11; B64U 50/19

(52) U.S. Cl. CPC B64U 30/29; B64U 10/10; B64U 50/11; B64U 50/19

(57) ABSTRACT

Systems and methods for controlling hybrid aerial vehicles. A flight control unit synchronizes an electric motor driven steering control rotor apparatus to control torque forces and a separate fuel powered lift control apparatus to control linear force to maneuver the aerial vehicle by providing lift control instructions to control internal combustion engines driving lift rotors and providing steering control instructions to electric motors driving steering control rotors as required to maneuver the vehicle.

### CROSS-REFERENCE TO RELATED APPLICATIONS

This application claims the benefit of priority from U.S. Provisional Patent Application No. 63/331,301, filed Apr. 15, 2022 the contents of which are incorporated by reference in their entirety.

### FIELD OF THE DISCLOSURE

The disclosure herein relates to systems and methods for providing unmanned aerial vehicles with extended ranges. In particular, the disclosure relates to hybrid multirotor drones.

### BACKGROUND

The world of unmanned aerial vehicles is divided into three broad families: fixed wing, helirotor and hybrid, and multirotor drones. Of the three families, the multi-rotor drones are particularly useful for their high maneuverability, simplicity of operation and low costs. However multirotor drones have been limited by their small load carrying capacity, short flight ranges and low speeds.

The multirotor drones have no lift forces other than the vertical thrust provided by their vertically orientated propellors. Therefore, in order to maintain stability, multirotor vehicles must control each rotor motor at a very high rate, say at a frequency of 50 hertz up to 600 hertz and more. Because the internal combustion engine is not able to respond at such rates, only electric motors with high response frequencies are compatible with multirotor drones. Accordingly, since the energy source of the electric motors is batteries, energy consumption of multirotor drones is very high.

The limited energy storage of multirotor drones restricts their duration of flight, shortens their range and limits their carrying capacity for a useful payload. Alternative energy sources such as fuel cells, or gasoline generators have a lot of losses during energy conversion and are not scalable.

The need remains, therefore, for an efficient multirotor copter with longer flight times, extended range, and greater load capacity. The invention described herein addresses the above-described needs.

### SUMMARY OF THE EMBODIMENTS

According to one aspect of the presently disclosed subject matter, a system is introduced for controlling a hybrid aerial vehicle. The system may include a steering control rotor apparatus configured to control torque forces upon the hybrid aerial vehicle; a principal lift control apparatus configured and operable to control linear force upon the hybrid aerial vehicle; and a flight control unit configured and operable to synchronize the steering control apparatus and the principal lift control apparatus. Typically, the steering control rotor apparatus comprises a power source, at least one electric motor and a at least one steering rotor, the lift control apparatus comprises a fuel tank, at least one internal combustion engine and at least one lift rotor mechanism and the flight control unit comprises a synchronization manager configured and operable to synchronize the principal lift control apparatus and the steering control apparatus to maneuver the aerial vehicle.

Where appropriate, the flight control unit comprises a stabilization controller configured and operable to receive sensor input and to provide corrective control signals to the steering rotor mechanism.

Optionally, the stabilization controller may include at least one lift synchronization module configured and operable to control multiple lift providers and at least one navigation synchronization module configured and operable to maneuver the aerial vehicle. The at least one lift synchronization module may include a primary lift synchronization module configured and operable to receive sensor data and to generate control signals for synchronizing between multiple combustion engines of the principal lift providers. The at least one lift synchronization module may further include a secondary lift synchronization module configured and operable to receive sensor data and to generate auxiliary control signals for synchronizing between multiple electric motors of the steering control rotor apparatus to provide auxiliary lift. Optionally, the at least one navigation synchronization module is configured and operable to receive sensor data and to generate control signals for synchronizing the at least one electric motor and the at least one steering rotor of the steering control rotor apparatus so as to provide stability during maneuvering of the vehicle.

In particular examples of the control system, the steering control rotor apparatus may comprise four steering rotors arranged such that two steering rotors are configured to provide lift when rotating clockwise and two steering rotors are configured to provide lift when rotating anticlockwise.

Accordingly, the steering control rotor apparatus may be configured to control roll angle by synchronizing an increased rate of rotation in both of a first pair of adjacent steering rotors relative to a second pair of adjacent steering rotors. Similarly, the steering control rotor apparatus may be configured to control pitch angle by synchronizing an increased rate of rotation in both of a first pair of adjacent steering rotors relative to a second pair of adjacent steering rotors. Alternatively or additionally, the steering control rotor apparatus may be configured to control yaw angle by synchronizing an increased rate of rotation in both of a first pair of clockwise steering rotors relative to a second pair of anticlockwise steering rotors.

Typically, the lift control apparatus may comprise a first lift rotor mechanism configured to provide lift when rotating clockwise and a second lift rotor mechanism configured to provide lift when rotating anticlockwise. Where appropriate, the lift control apparatus comprises a first internal combustion engine configured and operable to drive a first lift rotor mechanism and a second internal combustion engine configured and operable to drive a second lift rotor mechanism.

Alternatively, the lift control apparatus may comprises a common internal combustion engine a first transmission line, a second transmission line, a first lift rotor mechanism and a second lift rotor mechanism, wherein the first lift rotor mechanism is mechanically connected to the common internal combustion engine via the first transmission line and the second lift rotor mechanism is mechanically connected to the common internal combustion engine via the second transmission line. Accordingly, the second transmission line is configured and operable to drive the second lift rotor mechanism so as to counter torque of the first lift rotor mechanism. For example, the first transmission line may be configured and operable to drive the first lift rotor mechanism clockwise and the second transmission line may be configured and operable to drive the second lift rotor mechanism anticlockwise. Additionally or alternatively the lift control apparatus may be configured to tilt at least one of the first lift rotor mechanism and the second lift rotor mechanism.

In other embodiments of the hybrid aerial vehicle control system the lift control apparatus comprises a single lift rotor mechanism.

In another aspect of the current invention a method is taught for controlling a hybrid multi-rotor aerial vehicle, the hybrid multi-rotor aerial vehicle comprising a steering control rotor apparatus, a lift control apparatus, a flight control unit and a sensor unit.

The method may comprise: the flight control unit providing lift control instructions to the lift control apparatus; the flight control unit providing steering control instructions to the steering control apparatus; the lift control arrangement controlling the power of at least one internal combustion mechanism according to the lift control instructions; the at least one internal combustion mechanism driving at least one lift rotor mechanism at a required rate of rotation thereby generating a required linear lift force exerted upon the hybrid aerial vehicle; the steering control rotor apparatus controlling the power of at least one electric motor according to the steering control instructions; and the at least electric motor driving at least one steering rotor at a required rate of rotation thereby generating a required torque force upon the hybrid aerial vehicle.

Where appropriate, the step of driving at least one lift rotor mechanism at a required rate of rotation comprises a common internal combustion engine driving a first lift rotor clockwise and a second lift rotor anticlockwise, typically so as to counter torque of the first lift rotor mechanism. Additionally or alternatively, the step of driving at least one lift rotor mechanism at a required rate of rotation comprises a first internal combustion engine driving a first lift rotor clockwise and a second internal combustion engine driving a second lift rotor anticlockwise.

Typically, the step of controlling the power of at least one electric motor according to the steering control instructions comprises: communicating a first steering control signal to a first electric motor; communicating a second steering control signal to a second electric motor; communicating a third steering control signal to a third electric motor; and communicating a fourth steering control signal to a fourth electric motor. Accordingly, a first pair of the electric motors may drive a first pair of steering rotors clockwise and a second pair of the electric motors may drive a second pair of steering rotors clockwise.

Furthermore, a first pair of the electric motors may drive a first pair of steering rotors at a first rotation rate and a second pair of the electric motors may drive a second pair of steering rotors at a second rotation rate. Accordingly, the first pair of electric motors may be adjacent to each other and the second pair of electric motors may be adjacent to each other thereby generating a lateral lift differential and tilting the hybrid aerial vehicle. Additionally or alternatively, the first pair of electric motors may drive a first pair of steering rotors clockwise and the second pair of electric motors may drive a second pair of steering rotors clockwise thereby controlling a yaw moment upon the hybrid aerial vehicle.

### BRIEF DESCRIPTION OF THE FIGURES

For a better understanding of the embodiments and to show how it may be carried into effect, reference will now be made, purely by way of example, to the accompanying drawings. With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 is a block diagram schematically representing selected functional elements of an embodiment of a hybrid aerial vehicle having a fuel powered lift control apparatus and an electric powered steering control apparatus;

FIG. 2 is another block diagram representing a possible configuration of functional elements of a second embodiment of a hybrid aerial vehicle for controlling the fuel powered lift control apparatus and the electric powered steering control apparatus;

FIGS. 3A-C are respectively isometric, top and side views of a possible hybrid aerial vehicle having two internal combustion engine powered lift rotors and four electric powered steering rotors;

FIGS. 4A-C are respectively isometric, top and side views of an alternative hybrid aerial vehicle having one internal combustion engine powered lift rotors with four electric powered steering rotors; and

FIGS. 5A-I are top views of the hybrid aerial vehicle of FIGS. 4A-C illustrating possible rotor operational modes used to navigate and maneuver.

### DETAILED DESCRIPTION

Aspects of the present disclosure relate to unmanned aerial vehicles. In particular, the disclosure relates to hybrid multirotor drones which have longer flight times, and extended ranges.

An integrated solution includes separate but synchronized apparatus for lift and steering control. A fuel powered principal lift control apparatus provides principal vertical thrust required for lift and an electric powered steering control apparatus provides auxiliary vertical thrust as well as the fast response time required for steering and navigation.

Accordingly, the steering control apparatus, in addition to stabilizing, maneuvering and steering the vehicle, may also compensate for the slow response time and the delayed action of combustion engines in response to control signals and where required may further provide redundancy as an auxiliary lift control apparatus for example in the case of motor failure in the principal lift control apparatus.

The fuel powered principal lift control apparatus may include at least one lift rotor, a at least one storage tank and a at least one combustion engine configured and operable to convert fuel energy directly to mechanical motion in the rotors thereby providing the vertical thrust required to maintain lift.

It has been found that such a fuel powered principal lift control apparatus may save about 25% of the energy consumed as compared with systems which use electric motors to provide lift and employ fuel powered combustion engines only to generate electricity for driving the electric motors. Furthermore, because maneuvering is provided by separate steering rotors, the dedicated lift rotor may be fixed along one axis with no need to adjust the propellor angle. Accordingly, the drone may be mechanically straightforward and less costly to produce and maintain.

It will be appreciated that a dedicated fuel powered lift-propellor arrangement may also enable a larger cargo to be carried than would electric motor rotors of a typical multirotor drone. Indeed it has been found that such a configuration may allow the carrying of a useful cargo that is tens of percent larger even than helicopters or fixed wing configurations in proportion to the size of the vessel.

Accordingly, control of the vehicle may be maintained by a synchronization manager configured and operable to synchronize operation of the multiple motors and rotors included in the principal lift control apparatus and the steering control rotor apparatus.

The synchronization manager may, for example, include lift synchronization modules for controlling multiple lift providers and navigation synchronization modules. Lift synchronization modules may typically involve primary lift synchronization modules which receive sensor data and use this to generate control signals for synchronizing between multiple combustion engines of the principal lift providers. In addition, secondary lift synchronization modules may generate auxiliary control signals to the electric motors to further synchronize lift management with an auxiliary lift control apparatus. Navigation synchronization modules may provide still further control signals to the electric motors to synchronize the electric motors to drive individual steering rotors so as to provide stability when maneuvering the vehicle.

It is estimated that a hybrid drone such as described herein, may allow great flexibility and scalability beyond the platform with a useful load of say 40 kg per hour Such a structure may allow missions at double flight speed and which last longer greatly increasing the range of the vehicles.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally, or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

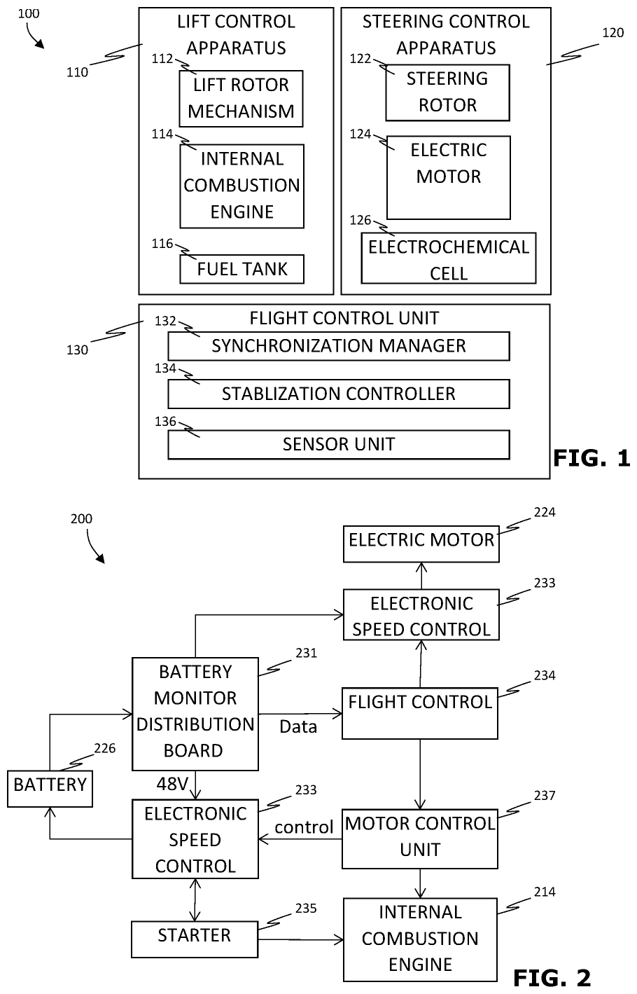

Reference is now made to the block diagram of FIG. 1 which schematically represents selected functional elements of an embodiment of a hybrid aerial vehicle control system 100. The hybrid aerial vehicle control system 100 includes an internal combustion engine powered lift control apparatus 110, an electric powered steering control apparatus 120, and a flight control unit 130.

The fuel powered lift control apparatus 11 includes a fuel tank 116, an internal combustion engine 114 and a lift rotor mechanism 112. The fuel tank 116 holds a reservoir of fuel typically a hydrocarbon such as petroleum, gasoline, diesel or the like and is typically connected to the internal combustion engine via a fuel line. The internal combustion engine 114 is mechanically configured to drive the lift rotor mechanism 112 directly or via gearing mechanisms. The lift rotor mechanism 112 is typically a propeller or multiple propeller arrangement operable to generate vertical thrust which provides the vehicle with lift.

The electric powered steering control apparatus includes an electrochemical cell power source 126, an electric motor 124 and a steering rotor mechanism 122. The electrochemical cell 126 is connected to the electric motor 124 and may be used to power the electric motor 124 to drive the steering rotor mechanism 122. The steering rotor mechanism 122 includes a rotor arrangement operable to tilt the lift rotor mechanism 122 such that the vehicle may be steered as required.

The flight control unit 130 incudes a synchronization manager 132, a stabilization controller 134 and a sensor unit 136. The synchronization manager 132 synchronizes the lift control apparatus 110 and the steering control apparatus 120 such that the aerial vehicle may be maneuvered as required. The stabilization controller 134 provides corrective control signals to the steering rotor mechanism 120 typically in response to sensor input from the sensor unit 136 in order to maintain stability of the vehicle. The sensor unit 136 may include various sensors such as accelerometers, cameras, orientation sensors and the like as required.

Referring now to the block diagram of FIG. 2, which represents an example of a possible configuration of functional elements of a control system 200 of a second embodiment of a hybrid aerial vehicle. The control system 200 includes a battery 226, a battery monitor distribution board 231, an electric speed controller 233, an electric motor 224, a flight controller 234, a motor control unit 237, an internal combustion engine 214, an electronic speed control 233 and a starter 235.

The flight control 234 may provide control instructions to both the motor control unit 237 and the electronic speed control 233. Accordingly, coordinated control signals may be sent to the electric motors 224 to control the steering rotors and to the internal combustion engine 214 to control the lift rotor mechanism. It is noted that, where required, the battery 226 or electrochemical cells may be monitored and recharged by the internal combustion engine 214.

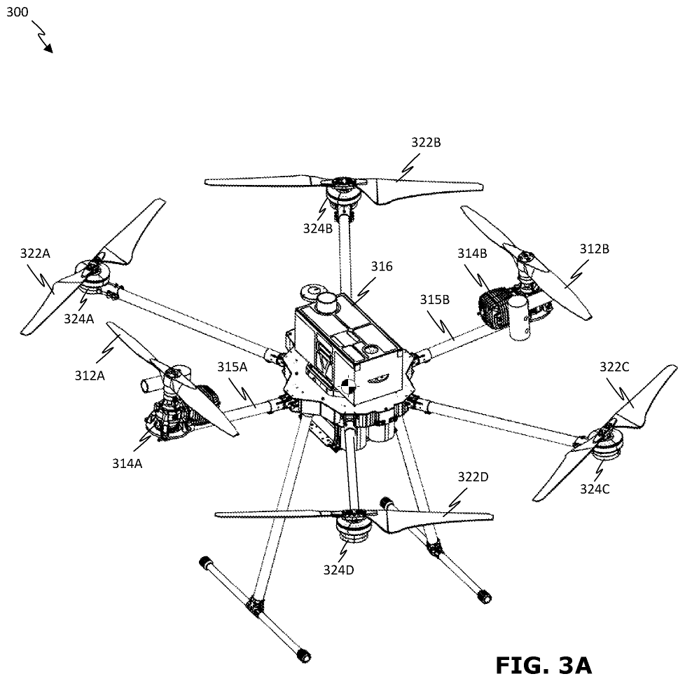

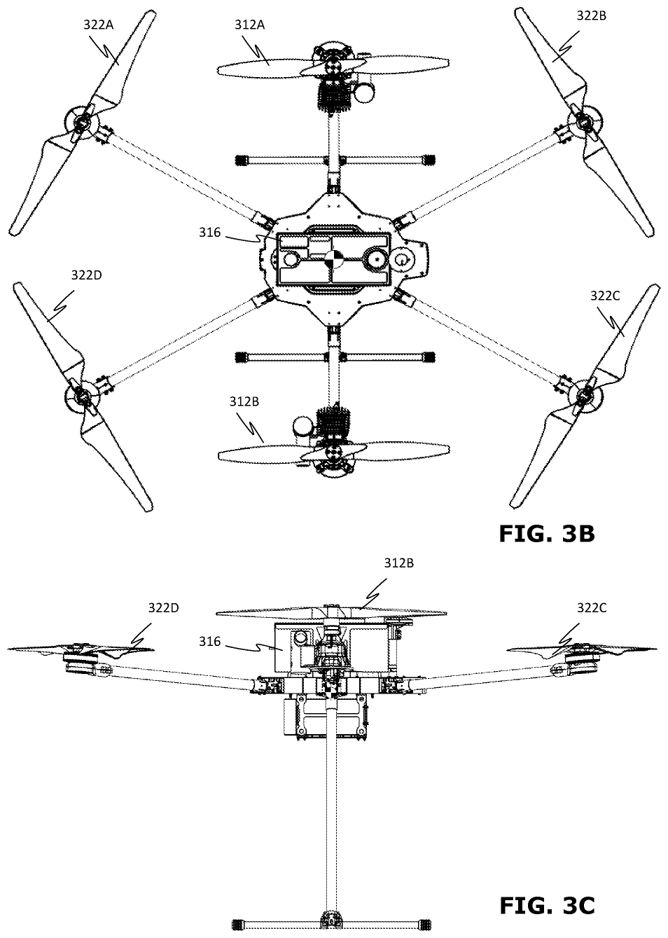

With reference to FIGS. 3A-C, isometric, top and side views are provided for illustrative purposes of a possible hybrid aerial vehicle 300 having two fuel powered lift rotors 312A, 312B and four electric powered steering rotors 322A-D.

Each of the two fuel powered lift rotors 312A, 312B is driven by an internal combustion engine 314A, 312B. A central fuel tank 316 is connected via fuel lines 315A, 315B to carburetors which provide fuel air admixture to the two internal combustion engine which in turn drive the lift rotors 312A, 312B. It is noted that the lift rotors 312A, 312B are mounted to fixed axes such that they cannot tilt, in order to tilt the lift rotors, the steering rotor arrangement tilts the whole vehicle as required.

The four electric powered steering rotors 322A-D are each driven by a dedicated electric motor 324A-D which can be controlled individually to provide the desired thrust from each of the steering rotors 312A, 312B.

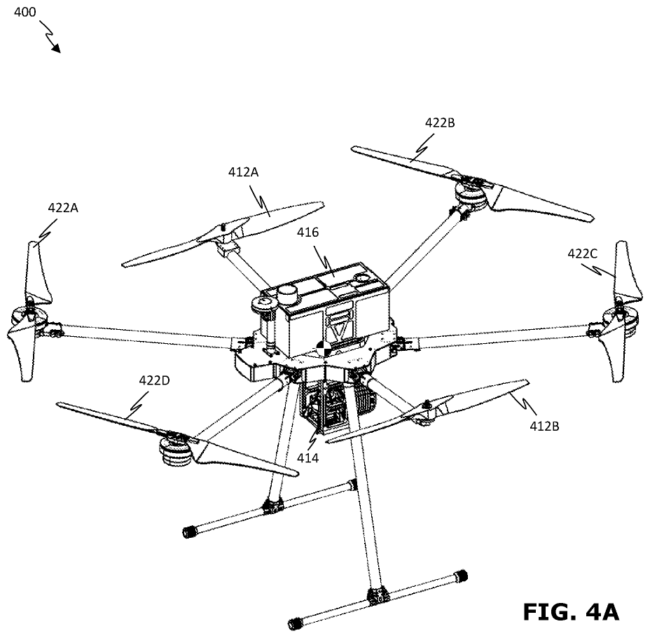

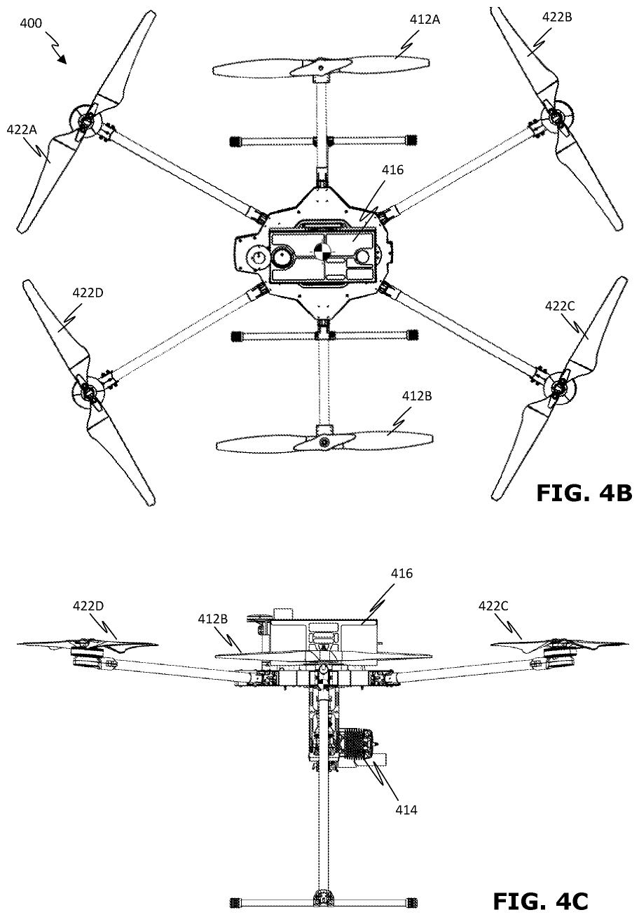

Referring now to FIGS. 4A-C isometric, top and side views of an alternative hybrid aerial vehicle 400 having two fuel powered lift rotors 412A, 412B and four electric powered steering rotors 422A-D.

In the alternative embodiment of the hybrid vehicle the two fuel powered lift rotors 412A, 412B are driven by a common central internal combustion engine 414 located near the central fuel tank 416. A first mechanical transmission line may be provided between the engine 414 and the a first lift propellor 412A and a second mechanical transmission line may be provided between the engine 414 and the a second lift propellor 412B. Preferably the lift propellors 412A, 412B are driven in opposite directions such that each lift propellor cancels the angular momentum of the other thereby preventing spin or rotation of the vehicle about its central axis.

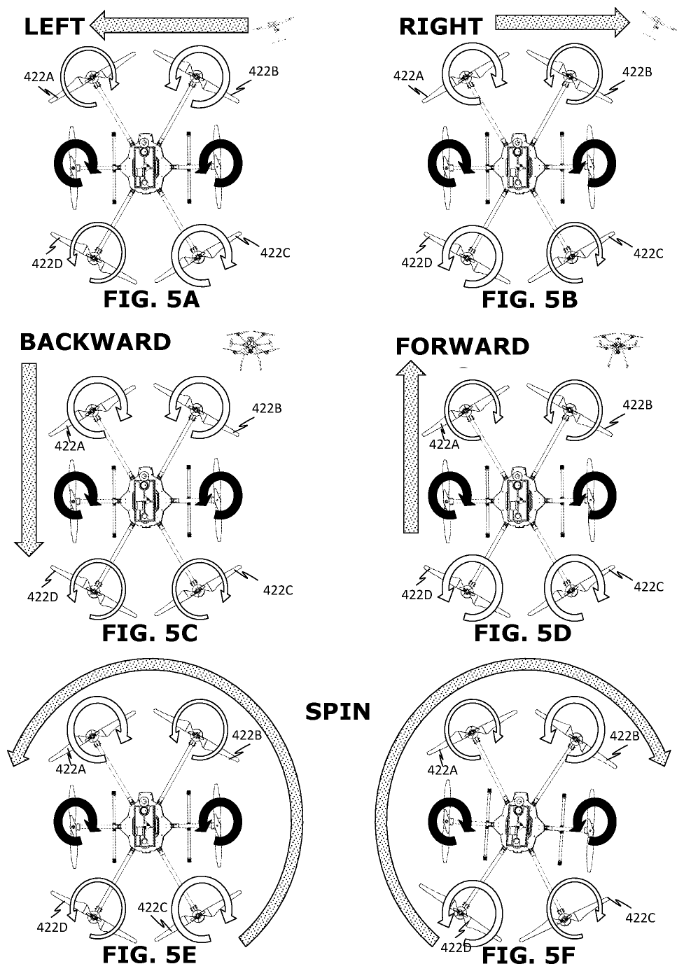

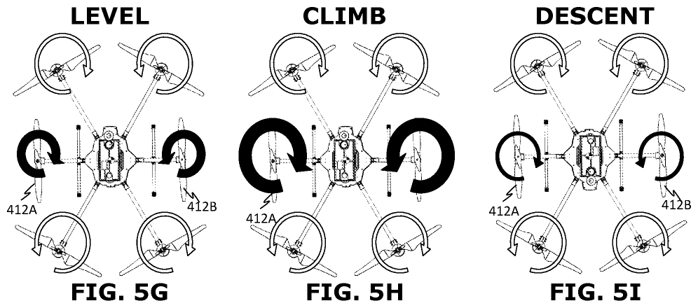

Reference is now made to FIGS. 5A-I which are top views illustrating possible rotor operational modes used to navigate and maneuver of the alternative embodiment of the hybrid aerial vehicle shown in FIGS. 4A-C. It is noted that the direction and speed of the rotors are indicated by circular arrows with thicker arrows representing faster propellor speeds. For ease of distinction, motion of the lift rotors 412A, 412B is represented in solid black arrows and motion of the steering rotors 422A-D is represented by white arrows.

Referring to FIG. 5A, the direction of motion of the aerial vehicle 400 may be controlled by the steering rotors 422A-D to move the vehicle leftwards by running the two rightside steering rotors 422B, 422C at higher speed than the leftside rotors 422A, 422D. Thus, greater lift is generated at the right tilting the vehicle such that the roll angle increases to the left and the thrust vector of the propellors gains a leftward component.

Similarly, referring to FIG. 5B, the direction of motion of the aerial vehicle 400 may be controlled by the steering rotors to move the vehicle rightwards by running the two leftside steering rotors 422A, 422D at higher speed than the rightside rotors 422B, 422C. Thus, greater lift is generated at the left tilting the vehicle such that the roll angle increases to the right and the thrust vector of the propellors gains a rightward component.

Similarly, referring to FIG. 5C, the direction of motion of the aerial vehicle 400 may be controlled by the steering rotors to move the vehicle backwards by running the two front steering rotors 422A, 422B at higher speed than the rear rotors 422C, 422D. Thus, greater lift is generated at the front tilting the vehicle such that the pitch angle increases to the rear and the thrust vector of the propellors gains a backward component.

Similarly, referring to FIG. 5D, the direction of motion of the aerial vehicle 400 may be controlled by the steering rotors to move the vehicle forwards by running the two rear steering rotors 422C, 422D at higher speed than the front rotors 422A, 422B. Thus, greater lift is generated at the rear tilting the vehicle such that the pitch angle increases to the front and the thrust vector of the propellors gains a foreword component.

It is particularly noted that the direction of each rotor is selected such that the total angular momentum of the propellors is zero. Thus, the clockwise angular momentum generated by the left lift propellor 412A is exactly balanced by the anticlockwise angular momentum generated by the right lift propellor 412B. Likewise, the clockwise angular momentum generated by both the front-left 422A and the rear-right 422C steering propellors is exactly balanced by the anticlockwise angular momentum generated by both the front-right 422B and the rear-left 422D steering propellors

Referring now to FIGS. 5E and 5F, the vehicle may be controlled to spin about its central axis by increasing the angular momentum of steering propellors 422A-D, thereby controlling the yaw angle as required. Thus, as shown in FIG. 5E increasing the speed of the clockwise rotation of the front-left propellor 422A and the rear-right propellor 422C results in an anticlockwise rotation of the vehicle. Similarly, as shown in FIG. 5F increasing the speed of the anticlockwise rotation of the front-right propellor 422B and the rear-left propellor 422D results in a clockwise rotation of the vehicle.

It will be noted that in order to control vertical motion of the vehicle, the lift propellors 412A, 412B may be utilized. FIG. 5G illustrates that during level flight the speed of the lift propellors 412A, 412B is selected such the lift exactly matches the weight of the vehicle. As shown in FIG. 5H the vehicle may climb by increasing the speed of the lift propellor 412A, 412B such that the lift exceeds the weight of the vehicle resulting in a net upwards force and therefore accelerating the vehicle upwards. Likewise, as shown in FIG. 5I, by reducing the speed of the lift propellors 412A, 412B, the lift may be reduced below the weight of the vehicle resulting in a net downwards force and therefore accelerating the vehicle downwards for a descent.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims. Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

### Technical Notes

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A hybrid aerial vehicle control system comprising:
a steering control rotor apparatus configured to control torque forces upon the hybrid aerial vehicle;
a principal lift control apparatus configured and operable to control principal linear force upon the hybrid aerial vehicle; and
a flight control unit configured and operable to synchronize the steering control apparatus and the lift control apparatus to control and balance total angular momentum of the vehicle;
wherein:
the steering control rotor apparatus comprises a power source, at least one electric motor and at least one steering rotor mechanism, and
the lift control apparatus comprises a fuel tank, at least one internal combustion engine and at least one lift rotor mechanism.

2. The hybrid aerial vehicle control system of claim 1 wherein the flight control unit comprises a synchronization manager configured and operable to synchronize the principal lift control apparatus and the steering control apparatus to maneuver the aerial vehicle.

3. The hybrid aerial vehicle control system of claim 1 wherein the flight control unit comprises a stabilization controller configured and operable to receive sensor input and to provide corrective control signals to the steering rotor mechanism and the lift rotor mechanism.

4. The hybrid aerial vehicle control system of claim 1 wherein the steering control rotor apparatus comprises four steering rotors arranged such that two steering rotors are configured to provide lift when rotating clockwise and two steering rotors are configured to provide lift when rotating anticlockwise.

5. The hybrid aerial vehicle control system of claim 4 wherein the steering control rotor apparatus is configured to:
control roll angle by synchronizing an increased rate of rotation in both of a first pair of adjacent steering rotors relative to a second pair of adjacent steering rotors;
control pitch angle by synchronizing an increased rate of rotation in both of a third pair of adjacent steering rotors relative to a fourth pair of adjacent steering rotors; and
control yaw angle by synchronizing an increased rate of rotation in both of a fifth pair of clockwise steering rotors relative to a sixth pair of anticlockwise steering rotors.

6-7. (canceled)

8. The hybrid aerial vehicle control system of claim 1 wherein the lift control apparatus comprises a first lift rotor mechanism configured to provide lift when rotating clockwise and a second lift rotor mechanism configured to provide lift when rotating anticlockwise.

9. The hybrid aerial vehicle control system of claim 1 wherein the lift control apparatus comprises a first internal combustion engine configured and operable to drive a first lift rotor mechanism and a second internal combustion engine configured and operable to drive a second lift rotor mechanism.

10. The hybrid aerial vehicle control system of claim 1 wherein the lift control apparatus comprises a common internal combustion engine a first transmission line, a second transmission line, a first lift rotor mechanism and a second lift rotor mechanism, wherein the first lift rotor mechanism is mechanically connected to the common internal combustion engine via the first transmission line and the second lift rotor mechanism is mechanically connected to the common internal combustion engine via the second transmission line.

11. The hybrid aerial vehicle control system of claim 10 wherein the second transmission line is configured and operable to drive the second lift rotor mechanism so as to counter torque of the first lift rotor mechanism.

12. The hybrid aerial vehicle control system of claim 11 wherein the first transmission line is configured and operable to drive the first lift rotor mechanism clockwise and the second transmission line is configured and operable to drive the second lift rotor mechanism anticlockwise.

13. A method for controlling a hybrid multi-rotor aerial vehicle, the hybrid multi-rotor aerial vehicle comprising a steering control rotor apparatus, a lift control apparatus, a flight control unit and a sensor unit, the method comprising:
the flight control unit providing lift control instructions to the lift control apparatus;
the flight control unit providing steering control instructions to the steering control apparatus;
the lift control arrangement controlling the power of at least one internal combustion mechanism according to the lift control instructions;
the at least one internal combustion mechanism driving at least one lift rotor mechanism at a required rate of rotation thereby generating a required linear lift force exerted upon the hybrid aerial vehicle;
the steering control rotor apparatus controlling the power of at least one electric motor according to the steering control instructions; and
the at least electric motor driving at least one steering rotor at a required rate of rotation thereby balancing total angular momentum of the vehicle and generating a required torque force upon the hybrid aerial vehicle.

14. The method of claim 13 wherein the step of driving at least one lift rotor mechanism at a required rate of rotation comprises driving a second lift rotor mechanism so as to counter torque of a first lift rotor mechanism.

15-16. (canceled)

17. The method of claim 13 wherein the step of controlling the power of at least one electric motor according to the steering control instructions comprises:
communicating a first steering control signal to a first electric motor;
communicating a second steering control signal to a second electric motor;
communicating a third steering control signal to a third electric motor; and
communicating a fourth steering control signal to a fourth electric motor.

18. The method of claim 17 wherein: a first pair of the electric motors drive a first pair of steering rotors clockwise and a second pair of the electric motors drive a second pair of steering rotors clockwise.

19. (canceled)

20. The method of claim 17 wherein a first pair of adjacent electric motors drive a first pair of steering rotors at a first rotation rate and a second pair of adjacent electric motors drive a second pair of steering rotors at a second rotation rate thereby generating a lift differential and tilting the hybrid aerial vehicle.

21. The method of claim 17 wherein a first pair of electric motors drive a first pair of steering rotors clockwise and a second pair of electric motors drive a second pair of steering rotors clockwise thereby controlling a yaw moment upon the hybrid aerial vehicle.

22. A hybrid aerial vehicle control system comprising:
a principal lift control apparatus configured and operable to control principal linear force upon the hybrid aerial vehicle;
a steering control rotor apparatus configured to control torque forces upon the hybrid aerial vehicle and to provide auxiliary lift control;
a flight control unit configured and operable to synchronize the steering control apparatus and the lift control apparatus; and
wherein:
the lift control apparatus comprises a fuel tank, at least one internal combustion engine and at least one lift rotor mechanism
the steering control rotor apparatus comprises a power source, at least one electric motor and at least one steering rotor, and
the flight control unit comprises a synchronization manager including at least one lift synchronization module configured and operable to control multiple lift providers and at least one navigation synchronization module configured and operable to maneuver the aerial vehicle to control and balance total angular momentum of the vehicle.

23. The hybrid aerial vehicle control system of claim 22 wherein the at least one lift synchronization module comprises a primary lift synchronization module configured and operable to receive sensor data and to generate control signals for synchronizing between multiple combustion engines of the principal lift providers.

24. The hybrid aerial vehicle control system of claim 23 wherein the at least one lift synchronization module comprises a secondary lift synchronization module configured and operable to receive sensor data and to generate auxiliary control signals for synchronizing between multiple electric motors of the steering control rotor apparatus to provide auxiliary lift.

25. The hybrid aerial vehicle control system of claim 22 wherein the at least one navigation synchronization module is configured and operable to receive sensor data and to generate control signals for synchronizing the at least one electric motor and the at least one steering rotor of the steering control rotor apparatus so as to provide stability during maneuvering of the vehicle.
